(19) United States
(12) Patent Application Publication
(10) Pub. No.: US 2014/0124259 A1
(43) Pub. Date: May 8, 2014

(54) JUNCTION BOX WITH INTEGRATED CONDUIT SUPPORTS

(71) Applicant: M.C. Dean, Inc., Dulles, VA (US)

(72) Inventors: Bill Dean, Dulles, VA (US); Tracy Amos, Stanley, VA (US); Walter Rampey, Leesburg, VA (US); Michael Barnhart, Arnold, MD (US)

(21) Appl. No.: 13/907,206

(22) Filed: May 31, 2013

Related U.S. Application Data
(60) Provisional application No. 61/723,143, filed on Nov. 6, 2012.

(51) Int. Cl. H02G 3/08

(52) U.S. Cl. CPC H02G 3/08
USPC 174/481

(57) ABSTRACT

A junction box assembly includes a junction box, a support plate for supporting conduit extending from a side wall of the junction box and a support bracket extending for supporting conduit extending from an upper wall of the junction box. The support plate is mounted to the upper wall of the junction box or can be the upper wall and includes a flange portion extending beyond a perimeter of the junction box. The flange portion defines an aperture for attaching a conduit clamp thereto in substantial alignment with the conduit entry ports formed in the side wall. The support bracket is mounted adjacent to the conduit entry port formed in the upper wall of the junction box and includes an extension portion extending the support bracket distally from junction box and a mounting portion for attaching a conduit clamp thereto to support conduit extending from the upper wall of the junction box.

### CROSS REFERENCE TO RELATED APPLICATION

This application is related to U.S. Patent Application No. 61/723,143 entitled “System and Method to Streamline Building Constructions,” filed Nov. 6, 2012, the contents of which are incorporated herein by reference in their entirety.

### FIELD OF THE DISCLOSURE

The present description relates generally to junction or distribution boxes, such as for example, electrical junction boxes, and more particularly to a junction or distribution box with integrated conduit supports. The subject boxes also form part of a larger integrated building system that is the subject of a separate, related application identified herein.

### BACKGROUND OF RELATED ART

Junction boxes, such as, for example, electrical junction boxes are commonly installed above suspended or grid ceilings, or are exposed in order to provide secure enclosures for wiring and/or other connections so as to supply the various wiring needs including, for instance, electrical devices, network devices, lights, fans, outlets, etc.

One of the most commonly used electrical junction box is the classic 4×4 box, which is well known in the art. These common boxes typically have limitations in terms of the number of individual conduits that can enter and leave the box, limiting, for instance, their capacity and their arrangement based upon knockout orientation. Larger boxes with additional knockout arrangements are used especially in commercial construction where electrical and/or other wiring requirements, e.g., main power, back-up power, telecom/communications/networking, etc., of typical floors and rooms are upwards of twice that of other non-commercial establishments.

The installation of wiring, such as electrical wiring, in construction is typically subject to various building codes, such as the National Electrical Code (NEC) in order to assure safe, trouble free operation. For instance, in one NEC requirement, wiring must be run in protective conduit with all of the connections made within junction boxes that provide both protection and access. In these examples, both the conduit and the boxes must be securely mounted to structural supports and supported in accordance with the National Electrical Code. The junction boxes and conduit are placed at an elevation which allows room for ceiling segments to be lifted up and removed from their hanging framework to provide access for future maintenance. The electrical installation is supported in much the same manner as the suspended ceiling, by hangers anchored to the steel or concrete of the floor above.

The amount of time and materials required to install conduit in compliance with national and local building codes can be substantial. For example, national building codes tend to insist that conduit emerging from a box have some form of support within three feet of the box; such codes also require that a strap or other support be present along every ten feet of the entire conduit length. In complex installations, such as hospital rooms, there are often requirements for several different types of conduit systems. For example, normal power may be supplied by one set of conduit(s) and junction boxes, while emergency “back-up” power may be delivered via an independent, separate set of conduit. Further, telecommunications might have its own conduit system, all of these leading around the ceiling and/or walls of a single room.

Traditionally, support straps required by code take an experienced installer upwards of about twenty minutes to measure, cut, drill, assemble, and attach to an acceptable concrete or other attachment point. A common, complex commercial development with approximately fourteen to sixteen hanging conduit supports to deck (for boxes/conduits) can, therefore, take an electrician a substantial amount of time to mount appropriately. Still further, the material of the straps/hanging method/anchors and tools to complete attachment points also involve additional cost.

One example junction box, as described in U.S. Pat. No. 5,883,332, provides for conduit support only for those conduits extending from the side walls of the junction box. As described, a flat plate is provided to which an electrical junction box is centrally mounted with the plate extending circumferentially beyond the sides of the junction box. Conduits entering the junction box are supported by conduit clamps attached to the extended portions of the plate by clamping proximate the periphery thereof so as to permit alignment of the conduit clamps with the entering conduit. The junction box, however, fails to provide an integrated conduit support for conduit emerging from the upper wall of the junction box, and furthermore fails to provide any structural support for mounting the junction to a ceiling or the like. Yet further, the described junction box requires additional hardware for installation and assembly of the separate parts.

As such, there is a demonstrable need for a junction box having an integrated conduit support system for supporting conduit emerging from both the side wall and the upper wall of the junction box as well as providing an improved support attachment for mounting the junction box to a proper support surface. Still further, there is a demonstrable need for a junction box that is part of an overall integrated software system that allows for multiple designs and configurations of conduit systems to provide ease of installation, add support means, and optimize routing.

### BRIEF DESCRIPTION OF THE DRAWINGS

FIG. 1 is a front top perspective view of one example of a junction box assembly having an integrated conduit support system in accordance with the present disclosure.

FIG. 2 is a top plan view of the junction box assembly of FIG. 1.

FIG. 3 is a side perspective view of the junction box assembly of FIG. 1.

FIG. 4 is a bottom perspective view of the junction box assembly of FIG. 1.

FIG. 5 is a bottom perspective view similar to FIG. 4, showing the partial removal of the bottom wall of the junction box.

FIG. 6 is a detailed view of a conduit as supported by the junction box assembly of FIG. 1.

FIG. 7 is a detailed view of a support bracket of the junction box assembly of FIG. 1.

FIG. 8 is another detailed view of the support bracket of FIG. 7.

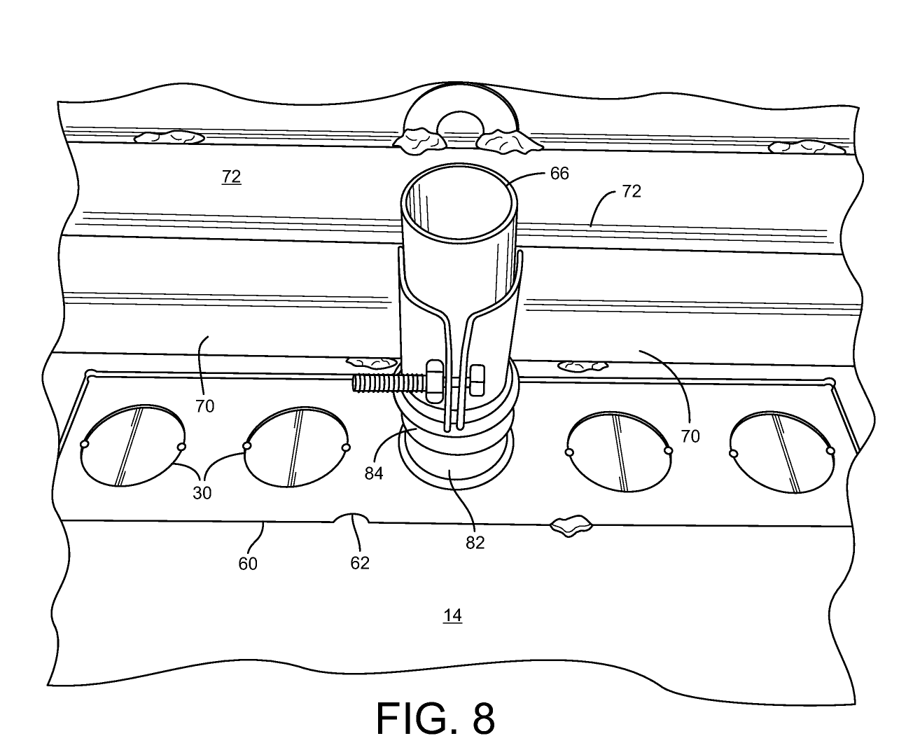

FIG. 9 is a bottom perspective view of an example of an octagonally shaped junction box assembly.

### DETAILED DESCRIPTION

The following description of example methods and apparatus is not intended to limit the scope of the description to the precise form or forms detailed herein. Instead the following description is intended to be illustrative so that others may follow its teachings.

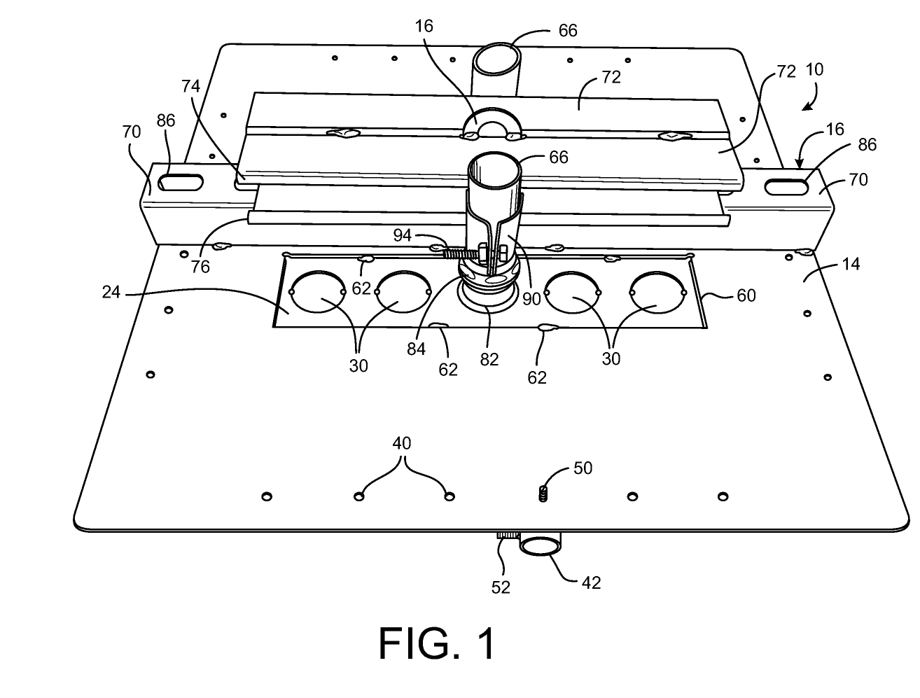

Referring generally to FIGS. 1-4, an example of a junction box with integrated conduit support assembly 10 is illustrated. The example assembly 10 includes a junction box 12, a support plate 14, and a support bracket 16. The junction box 12 is assembled to the support plate 14 and in turn to the support bracket 16 through any suitable fastening method, including for example, through welding, adhesion, mechanical fastener, spring washer, etc.

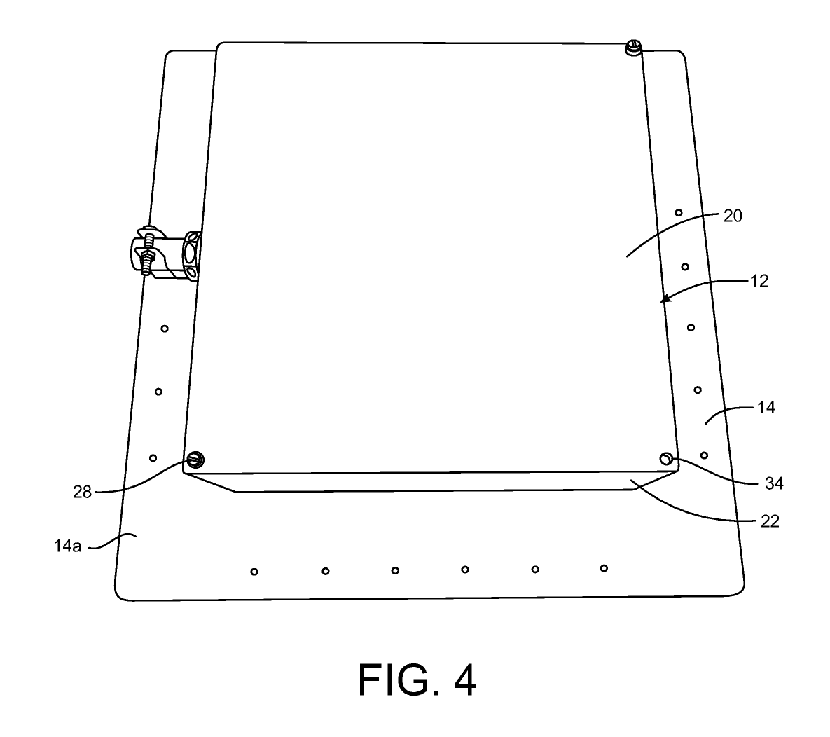

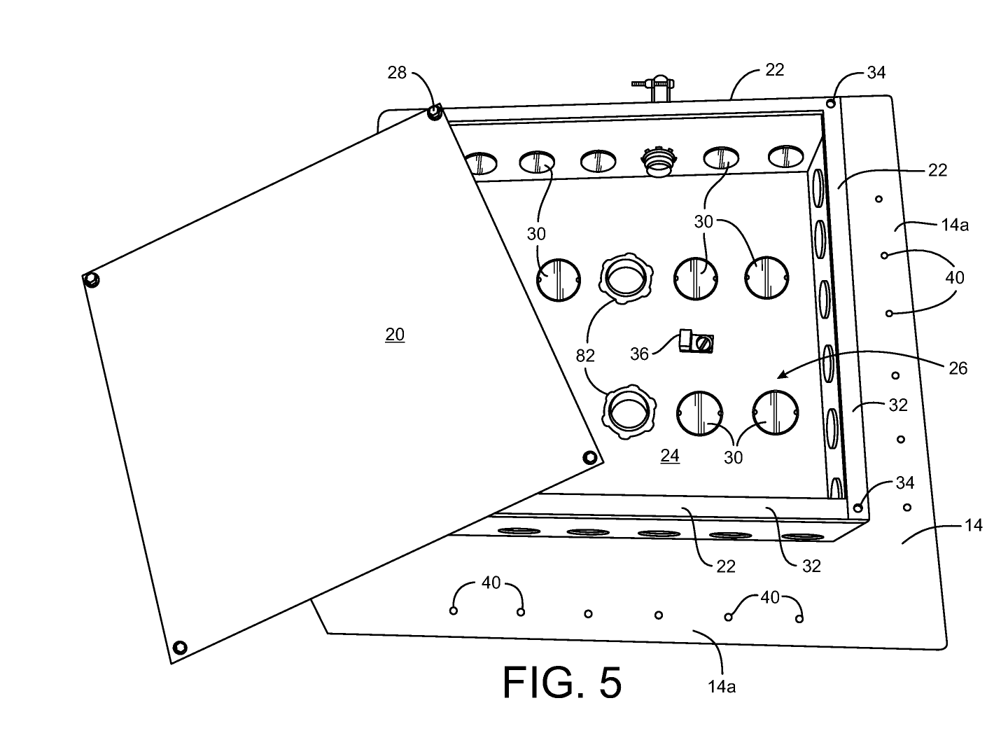

The example junction box 12 includes a top wall 24, four side walls 22, and a bottom wall 20 that is typically at least partially removable from the junction box 12 to provide access into the box for wiring, maintenance, etc. (see FIG. 5). Together, the top wall 24, side walls 22, and the bottom wall 20 define an inner space 26, configured to house electrical wiring and connections as known to one of ordinary skill in the art. The example junction box 12 may be U.S. National Electrical Manufacturers Association (NEMA) 1 rated and may comprise any suitable manufacturing material including, for instance, a 14 gauge sheet metal. While the present example illustrates a typical square-shaped junction box 12, the shape and/or dimensions of the junction box may vary as desired, or as required by code and/or installation requirements. Furthermore, while the example top wall 24 of the junction box 12 is separately formed from the support plate 14, it will be understood that the top wall 24 may alternatively be integrally formed with the support plate 14 as desired (i.e., the top wall 24 and the support plate are one element). As illustrated in FIG. 4, in this example, the top wall 24 and the bottom wall 20 both extend completely between the side walls 22 to completely enclose the inner space 26 when the bottom wall 20 is fastened and/or otherwise mounted to the junction box 12.

To mount the bottom wall 20, in this example, the junction box 12 includes four corners 32 and bent-over flanges 34 including a plurality of threaded apertures to retain a suitable fastener such as a threaded fastener 28. Additionally, a plurality of apertures and/or knockouts 30 are located in the top wall 24 and/or the side walls 22. As shown in FIG. 5, the example junction box 12 includes a grounding screw 36 mounted in this example to the upper wall 24 as may be required. It will be appreciated by one of ordinary skill in the art, that the junction box 12 may be formed from any suitable material, e.g., galvanized sheet metal, by any suitable manufacturing process including, for instance, welding, punching, folding, molding, etc.

The example assembly 10 also comprises the support plate 14, which in this example is mounted to the upper wall 24 of the junction box 12 via welding. As previously noted, the support plate 14 may be adhered to, integrally formed with, and/or otherwise mounted to the junction box 12. In this example, the support plate 14 is generally square in shape to correspond to the general shape of the junction box 12, although any other suitable shape, such as polygonal, circular, etc. may be suitably utilized. The example support plate 14 extends beyond the outer perimeter of the junction box 12, such that the support plate 14 generally forms a flange 14a extending outward from the side walls 22 of the junction box 12.

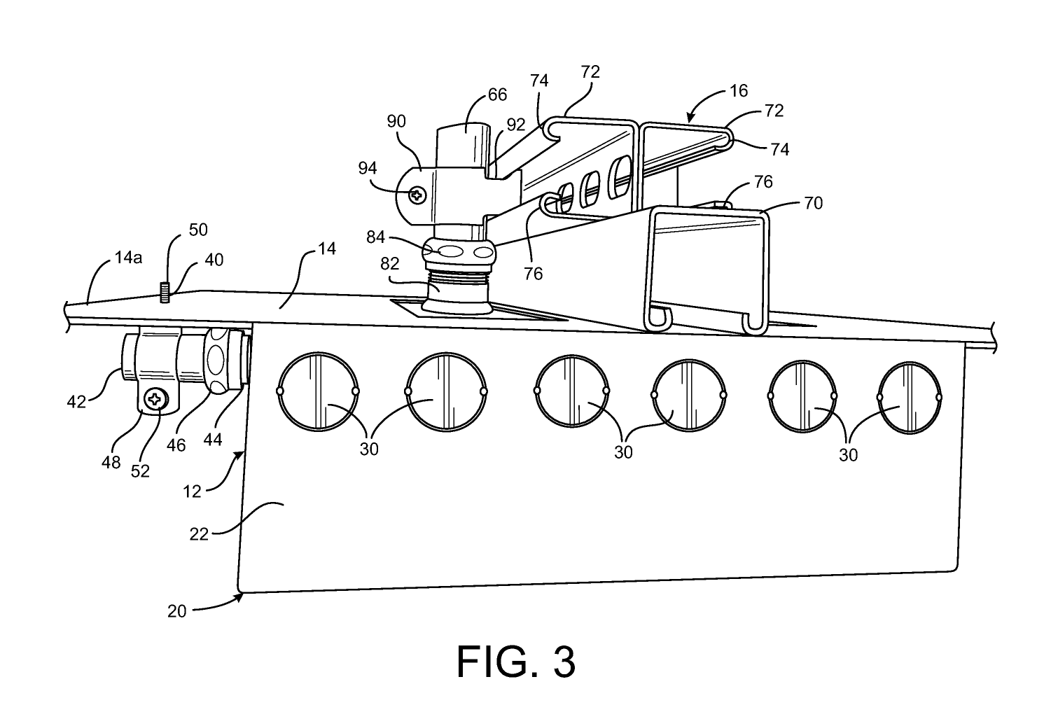

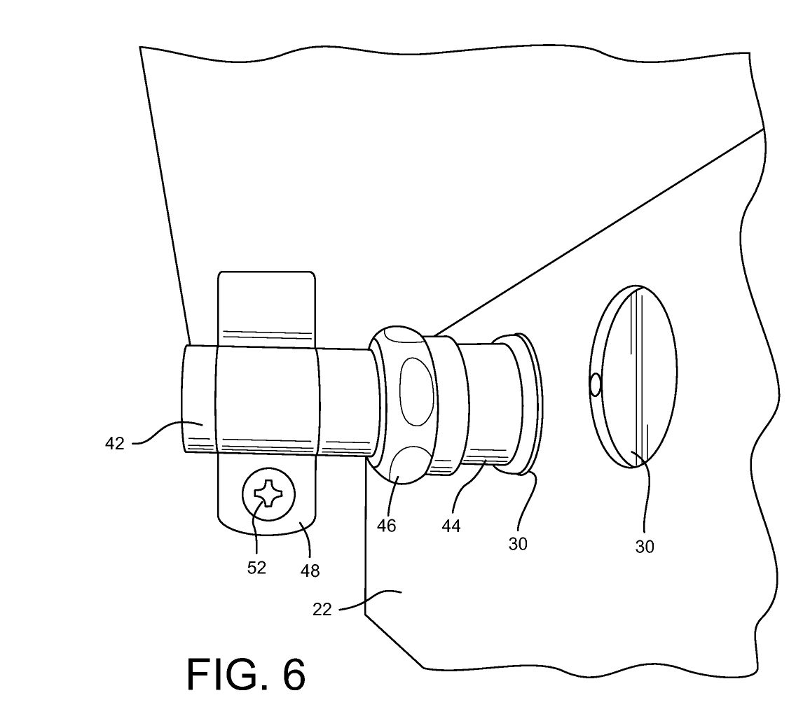

In this example, the formed flange 14a includes a plurality of apertures 40, such as threaded apertures and/or other suitable fastening mechanism to support a conduit 42 extending from the side walls 22. For instance, as best illustrated in FIGS. 3 and 6, the support of the example conduit 42 by the support plate 14 is more fully shown. In this example, the conduit 42 is installed for entry into the junction box 12, and more particularly the side wall 22 of the box 12 through a removed knockout 30 by a conduit entry fitting 44 and locked in place by a lock nut 46. A conduit clamp 48, which is a commercially available hardware item is clamped to the conduit 42 and mounted to the support plate 14 by a fastener 50, such as a machine screw passing through one of the apertures 40. The conduit clamp 48 is then clamped to the conduit 42 distal from the side wall 22 by any suitable fastener 52, including, for instance, a machine screw and nut. In this manner, any conduit extending from the side of the junction box 12 may be fully supported by the assembly 10 itself within the proper distance as may be required by code.

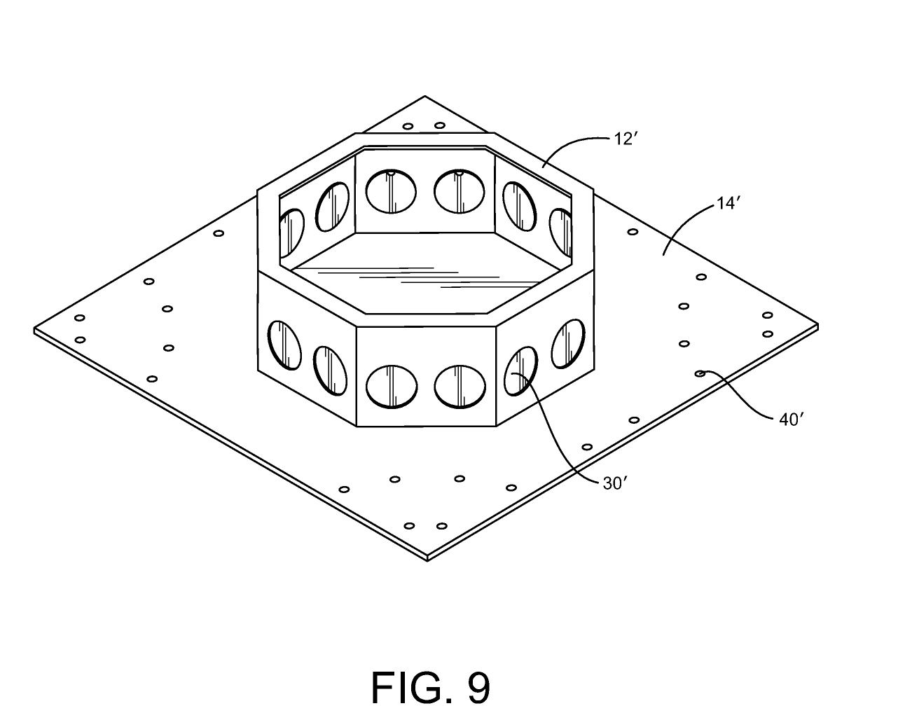

It will be appreciated by one of ordinary skill in the art that while a single conduit 42 is illustrated as extending from the junction box 12, additional conduit may extend from any or all of the knockouts 30 as desired. Additionally, while in the present example the apertures 40 are illustrated as discreetly formed holes, it will be appreciated that the apertures 40 may be formed as channels, slots, and/or any other suitable opening as desired to allow for multiple configurations of conduit and conduit clamps as desired. For instance, a generally elongated slot may be utilized to allow for adjacent conduits to be adjusted and/or bent so as obviating interference with each other in adjacent clamps 48. Still further, as described in conjunction with FIG. 9 below, different shapes and/or size of the junction box 20 may allow for additional conduit angles relative to the junction box side walls 22, thereby allowing the overall system design to be optimized without worry that all junction box connections need by at a predefined angle, such as for example at 90 degrees.

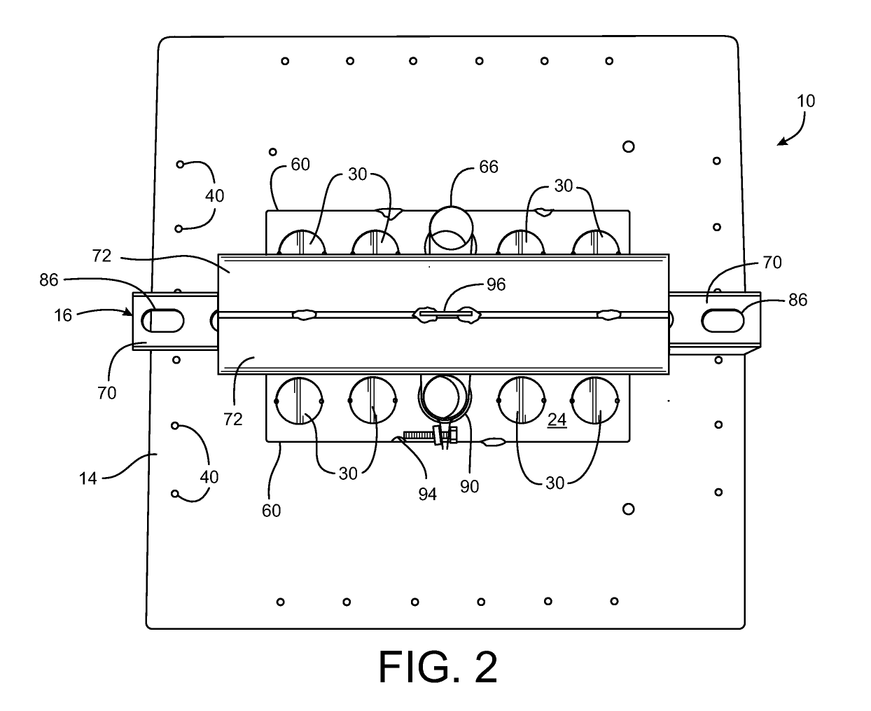

Referring again to FIGS. 1 and 2, the example support plate 14 is illustrated as having defined an least one aperture 60 exposing at least a portion of the upper wall 24 of the junction box 12. At shown, the example support plate 14 is spot welded 62 to the upper wall 24, but as noted, the support plate 14 may be attached by any suitable mechanism, such as for example spring washers, etc., and may furthermore be integrally formed with the upper wall 24 as desired. In the illustrated example, the apertures 60 expose a generally linear line of knockout formed in the upper wall 24 on either side of the support bracket 16. To provide additional strength and fastening surface for attaching the support plate 14 to the junction box 12 and for attaching the support bracket 16 to the support plate 14, the aperture 60 may be limited in size such that just the knockouts 30 are sufficiently exposed. As such, the arrangement of the knockouts 30 within the aperture(s) 60 may be any appropriate arrangement. For instance, in another arrangement, the support bracket 16 and the corresponding knockouts 30 may be arranged in a non-linear arrangement such as a circle so as to provide a conduit anchor point as disclosed herein.

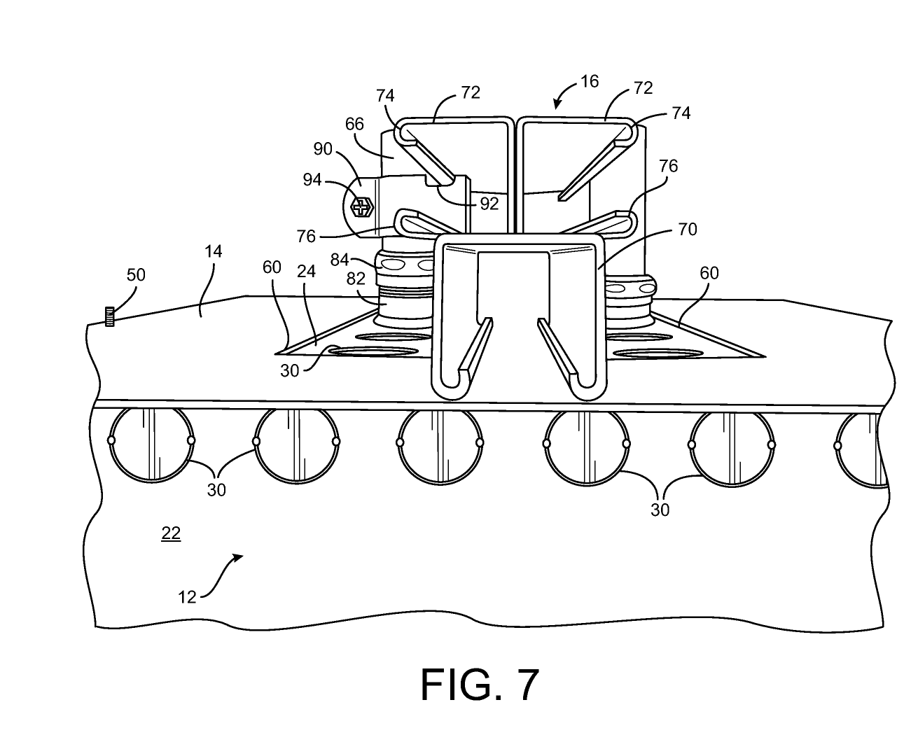

As further illustrated in FIG. 7, the example support bracket 16 comprises a three-channel box-like rail structure fastened to the support plate 14 through welding, fasteners, or the like. It will be appreciated that the support bracket 16 could be alternatively mounted directly to the junction box 12 as desired. The support bracket includes an extension portion extending the bracket 16 away from the surface of the upper wall 24, and a mounting portion for mounting conduit clamps thereto. In this example, the support bracket 16 includes a downward-facing channel 70 and two outward-facing channels 72 welded and/or otherwise fastened to the upper surface of the downward-facing channel 70. The downward-facing channel 70 provides rigidity to the support bracket 16 and furthermore extends the outward-facing channels 72 away from the knockout 30 on the upper wall 24 of the junction box 12 to provide sufficient space for a conduit 66 to be supported on the upper wall 24 of the junction box 12 through a removed knockout 30 by an entry fitting 82 and a lock nut 84. In this example, the downward-facing channel 70 extends generally the entire width of the support plate 14 and defines at least one aperture 86 on either end of the upper surface of the channel 70 to allow the junction box to be suspended and/or otherwise mounted to a ceiling and/or other support surface as is known in the art.

As noted, atop the downward-facing channel 70 are two mirror image horizontally facing channels 72. Each of the channels 72 extends generally parallel to the location of the knockouts 30 in the upper wall 24 of the junction box 12, which, in this instance, is generally linear. In addition, each of the example channels 72 includes an upper and lower lip and/or flange 74, 76 adapted to matingly support a conduit clamp 90, which similarly is a commercially available hardware item which may be clamped to the conduit 66 and mounted to the flanges 74, 76 defined in the channels 72 by channels 92 defined in the clamp 90. The conduit clamp 90 is then clamped to the conduit 66 distal from the upper wall 24 by any suitable fastener 94, including, for instance, a machine screw and nut. In this manner, any conduit extending from the upper side of the junction box 12 can be fully supported within the proper distance (e.g., within one to two inches from the junction box) as may be required by code. In addition, it will be understood that the ease in which the conduit clamp 90 may be installed within the channels 72 consequently allows the installer to forego any additional straps or investment of additional labor affixing such straps if the run of conduit emerging after the junction box 12 for at least ten feet so as to not exceed code standards (e.g., 10 feet).

While the support structure 16 is disclosed as a single down-facing channel 72 with a pair of outwardly facing channels 72, it will be understood that various other support structures may be utilized. For example, any of the channels 70, 72 may be formed as box tubes, cylinders, etc, with corresponding apertures for mounting the junction box and for supporting the conduit emerging from the upper wall of the junction box as described herein. Still further, the channels 70, 72 may be I shaped, J, shaped, etc. and/or the entire structure 16 may be a monolithic structure, (e.g., a single integrated structure).

As is best illustrated in FIGS. 1 and 2, the example channels 72 are shorter in length than the channel 70 to allow for the apertures 86 to be fully exposed and remain accessible for installing the junction box 12. In addition or alternatively, the assembly 10 may be installed by attaching a hanger to a centrally located fastening point such a loop 96, which in this example is centrally mounted between the upper channels 72. The advantage of providing multiple exposed attachment points 86, 96, is that while national code general only requires a single point of attachment, there are some local jurisdictions which may impose an obligation to have at least two attachment points for supporting junction box assemblies.

Still further, it will be understood that various methods of attaching the junction box assembly 10 to a support structure may be utilized. For example, the assembly could be supported by attaching a cable to the loop 96, by running a cable through the apertures 86, could be supported through a threaded rod and bolt through the pre-manufactured apertures 86, or any suitable combination of mounting processes. The flexibility provide by multiple attachment points allows for the single assembly 10 to be used in virtually all location regardless of varying attachment requirements.

While the above referenced assembly 10 is fully described and illustrated, it will be appreciated by one of ordinary skill in the art that various alternative shapes, sizes, and arrangements may be utilized without departing from the teachings of the present disclosure. For example, the size and/or shape of the junction box 12 and the arrangements of the knockouts 30 may be varied as desired. Similarly, the junction box 12 may be prefabricated for generic needs, or may be custom designed as desired. Likewise, the size and shape of the support plate 14 and/or the support bracket 16 may vary such that other shapes, sizes, and configuration of parts may suffice.

For instance, referring now to FIG. 9, there is illustrated another example assembly 10′ showing a generally octagon shaped junction box 12′ with an integrated support plate 14′. In some instances, the octagon shaped junction box 12′ may be a preferred embodiment due to its flexibility in configuration of conduit in the overall installation system. The example junction box 12′ is generally NEMA 1 rated and includes a suitable gauge material such as, for example, a 14 gauge galvanized sheet metal material. Each side of the octagon shaped junction box 12′ may include any appropriate sized and located knockout 30′, such as for example two on each side. Finally, as shown in FIG. 9, an arrangement of apertures 40′ may be defined in the support plate 14′ to correspond to the arrangement and predicted location of conduit extending from the junction box 12′. It will be appreciated that the arrangement of holes in the support plate 14′ may be standardized with the placement of holes in the support plate 14 of the previous example such that the same support plate may be utilized in various junction box shapes to assist and simplify the manufacturing of various embodiments of the junction box assemblies.

Due to the support arrangements of the presently described example multi-conduit box assemblies, the boxes may advantageously be affixed essentially near the center of a room. For example, allowing lengths of conduit having pre-determined bends but being precisely calculated to enter a particular knockout port in the conduit box and to terminate at a particular attachment point down along a wall can be done in a way that no second additional straps are required because the box is placed to ensure that none (or a minimum amount) of the conduit exceeds the required code limitation, for having to add a strap anchored to the ceiling (e.g., ten feet).

By modeling the entirety of the conduit system, and using software such as that described in related co-pending U.S. Ser. No. 61/723,143, incorporated herein by reference in its entirety, to calculate without human error all the various attachment and configuration points with this well thought out configuration, one can end up with pre-cut, pre-bent, pre-packaged pieces which can be shipped to the site and quickly assembled by the electricians at a much greater labor savings than is currently available. Moreover, because of the central location of the box/support within the center or above the center of the room ceiling, the runs of conduit at precise locations less than code limitations can thus eliminate the labor and additional straps and cut down on the type and quantity of tools required on-site.

An additional point to make is that the elated computer design system permits only prescribed elevations for the various types of electrical conduit systems that must be run. For example, general electrical power supply may be at a particular elevation, while emergency power is at a height sufficiently below that elevation so that conduit running from the two systems does not interfere with each other. Further below that might be the telecommunications and/or internet connectivity conduits. By setting and restricting the elevation ranges into tiers for the various runs of conduit, the computer eliminates what could be substantial deviations due to human judgment. The electrician does not face the case of trying to work around conduit that interferes with what he is working on. Instead, the tiers accommodate each pre-fabricated installation spec, and the box location in the central portion of the room further multiplies the efficiencies by having pre-fabricated, pre-determined distances for wall installations requiring a minimum of strapping.

This particular configuration of junction boxes and supports, having pre-determined tiered elevations and multiple but exact points of entry for conduit, work in concert with the related application describing a computerized system of calculating pre-fabricated runs of conduit and having machinery pre-bend and pre-package them for mass customization and delivery to large building sites.

It is, therefore, a distinct advantage of the present disclosure that the pre-determined, pre-fabricated junction box described herein that has punched holes in a specific configuration that can benefit anyone, the pre-drilled plate for straps, and having the cut away multi-attachment point channel system that adds to the overall system for improving and streamlining construction as part of a system.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. A junction box assembly comprising:
a junction box comprising at least one side wall and an upper wall defining an inner space, the at least one side wall and the upper wall comprising at least one conduit entry port;
a support plate mounted to at least a portion of the upper wall of the junction box comprising a flange portion extending beyond a perimeter of the at least one side wall, the flange defining an aperture for attaching a conduit clamp thereto in substantial alignment with a selected one of the conduit entry ports formed in the side wall; and
a support bracket mounted adjacent the at least one conduit entry port formed in the upper wall of the junction box, the support bracket comprising:
an extension portion extending the support bracket distally from the at least one conduit entry port formed in the upper wall of the junction box; and
a mounting portion comprising at least one mounting structure for attaching a conduit clamp thereto in substantial alignment with the at least one conduit entry port formed in the upper wall of the junction box.

2. A junction box assembly as recited in claim 1, wherein the junction box is polygonal in shape.

3. A junction box assembly as recited in claim 1, wherein the extension portion comprises a downward-facing channel such that the channel opening faces the upper wall of the junction box.

4. A junction box assembly as recited in claim 1, wherein the extension portion comprises at least one aperture on either end of the upper surface of the extension portion to matingly accept a support structure and to allow the junction box assembly to be mounted to a support surface.

5. A junction box assembly as recited in claim 4, wherein the mounting portion is limited in size so as to expose the at least one aperture on either end of the upper surface of the extension portion.

6. A junction box assembly as recited in claim 1, wherein the mounting portion comprises an outward-facing channel such that the channel opens generally parallel to the upper wall of the junction box.

7. A junction box assembly as recited in claim 6, wherein the outward-facing channel comprises at least one mounting lip adapted to matingly support the conduit clamp.

8. A junction box assembly as recited in claim 1, wherein the mounting portion includes a fastening point to matingly accept a support structure and to allow the junction box assembly to be mounted to a support surface.

9. A junction box assembly as recited in claim 8, wherein the fastening point is a centrally located loop.

10. A bracket system for supporting conduit entering a junction box having a side wall with a first conduit entry port and an upper wall having a second conduit entry port, the bracket system comprising:
a support plate mounted to the upper wall of the junction box, the support plate having a flange portion extending beyond a perimeter of the side wall, the flange defining an aperture for attaching a first conduit clamp thereto in substantial alignment with the first conduit entry port formed in the side wall; and
a support bracket mounted adjacent the second conduit entry port, the support bracket having an extension portion extending the support bracket distally from the second conduit entry port formed in the upper wall of the junction box, a mounting portion comprising at least one mounting structure for attaching a second conduit clamp thereto in substantial alignment with the second conduit entry port formed in the upper wall of the junction box.

11. A bracket system as recited in claim 10, wherein the extension portion comprises a downward-facing channel such that the channel opening faces the upper wall of the junction box.

12. A bracket system as recited in claim 10, wherein the extension portion comprises at least one aperture on either end of the upper surface of the extension portion to matingly accept a support structure and to allow the junction box assembly to be mounted to a support surface.

13. A bracket system as recited in claim 12, wherein the mounting portion is limited in size so as to expose the at least one aperture on either end of the upper surface of the extension portion.

14. A bracket system as recited in claim 10, wherein the mounting portion comprises an outward-facing channel.

15. A bracket system as recited in claim 14, wherein the outward-facing channel comprises at least one mounting lip adapted to matingly support the second conduit clamp.

16. A bracket system as recited in claim 10, wherein the mounting portion includes a fastening point to matingly accept a support structure and to allow the junction box assembly to be mounted to a support surface.

17. A bracket system as recited in claim 16, wherein the fastening point is a centrally located loop.
